(19) United States
(12) Patent Application Publication
(10) Pub. No.: US 2013/0176437 A1
(43) Pub. Date: Jul. 11, 2013

(54) Video Passcode

(71) Applicant: Erick Tseng, San Francisco, CA (US)

(72) Inventor: Erick Tseng, San Francisco, CA (US)

(21) Appl. No.: 13/348,089

(22) Filed: Jan. 11, 2012

(51) Int. Cl. H04N 7/18

(52) U.S. Cl. 348/156; 348/E07.085

(57) ABSTRACT

In one embodiment, comparing a first video provided by a user with a second video associated with an object; authenticating the user based on whether the first video matches the second video; and granting the user access to the object when the first video sufficiently matches the second video.

### TECHNICAL FIELD

This disclosure generally relates to user authentication.

### BACKGROUND

User authentication refers to the process of verifying and authenticating a person's (e.g., a computer or network user's) identity. It has a wide range of applications both online and offline, such as to protect users themselves or their personal information, to ensure security, to control and limit access to information, objects, or locations.

### BRIEF DESCRIPTION OF THE DRAWINGS

FIG. 1 illustrates an example method for authenticating a user with a video passcode.

FIG. 2 illustrates an example computer system.

### DESCRIPTION OF EXAMPLE EMBODIMENTS

There are many means to authenticate a user, one of which is using a passcode, which may be in the form of a password, pass phrase, or personal identification number (PIN). Often, a passcode is used to control access to an object, either physical (e.g., a device, a location, etc.) or virtual (e.g., an account, a computer file, a website, etc.). Typically, a predetermined passcode is associated with the object. When anyone wishes to access the object, he must provide the correct passcode, or access to the object is denied. More recently, with the advancement of image processing techniques, a passcode may also be in the form of a static image. Again, a predetermined image (e.g., an image of a user's face) is associated with an object. When a user wishes to access the object, a photograph of the user's face is obtained and compared to the passcode image associated with the object (e.g., using facial recognition techniques). The user is granted access to the object only if his face in the photograph matches the face in the passcode image associated with the object. However, these forms of passcode have various disadvantages. For example, passwords or PINs may be stolen or forgotten. With static images, a person may obtain an image of another person (e.g., by downloading an image the other person has posted to a public website) and use it to gain access to objects belonging to the other person.

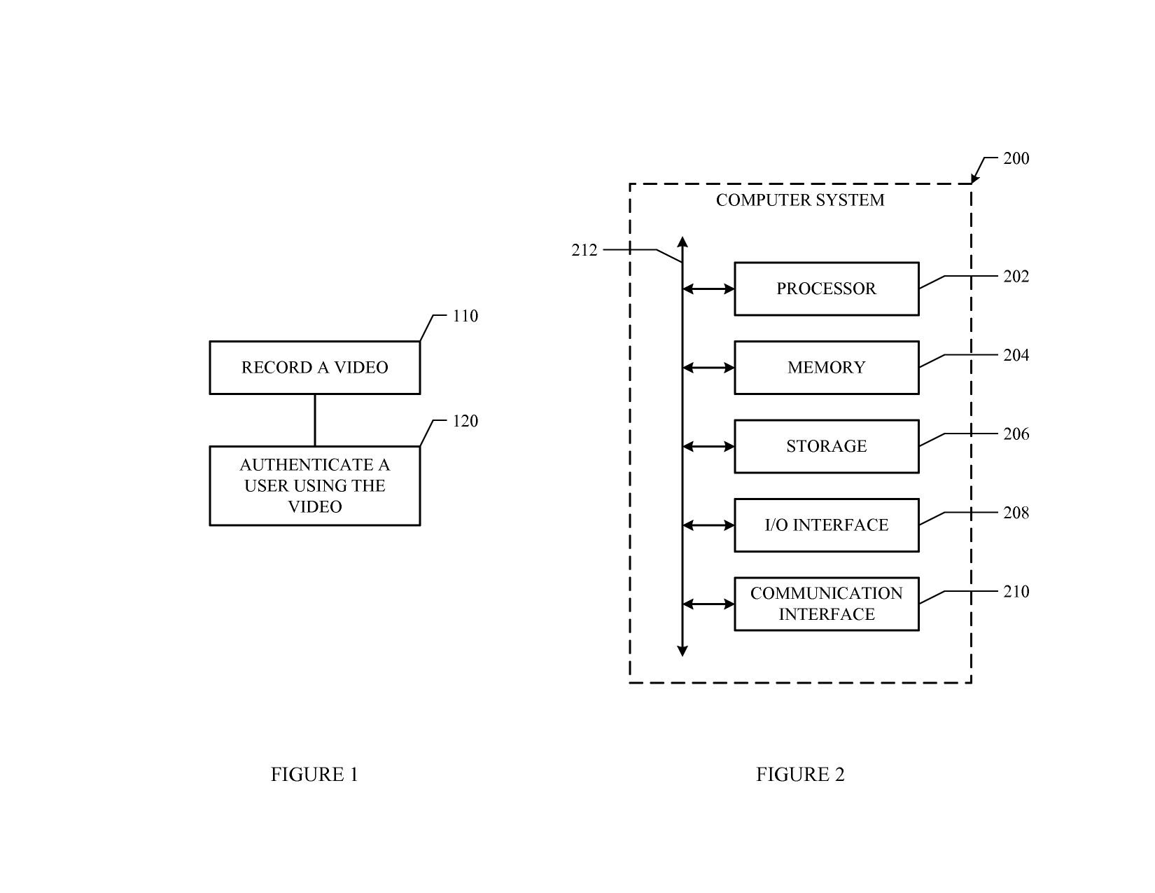

To improve access security through reliable user authentication, in particular embodiments, a passcode in the form of a video may be used to control access to a physical or virtual object. FIG. 1 illustrates an example method for authenticating a user using a video passcode. Again, the object may be a physical object, such as a device (e.g., a computer or a mobile telephone) or a location (e.g., a room or a building), or a virtual object, such as an account, a computer file, a database, or a website. In fact, a video passcode may be used with any applicable object.

In particular embodiments, a predetermined video passcode is associated with an object for controlling access to this specific object. The video used as a passcode may be pre-recorded and stored in the form of a video file. The video may be of any length (e.g., 5 to 10 seconds). In some implementations, the video used as a passcode includes a movement, such as a specific movement involving a user's face (e.g., a facial expression, such as a smile or a wink) or hand (e.g., a hand gesture, such as a wave or a finger snap), or a movement involving an object (e.g., a ball rolling across a surface). Any movement may be included in the video.

In particular embodiments, thereafter, when any user desires to access the object, the user must provide another video. In some implementations, the user may make a video recording at the time the user desires to access the object and supply this video recording as the passcode, as illustrated in STEP 110. The video supplied by the user is compared to the video passcode previously associated with the object, as illustrated in STEP 120. The user is granted access to the object only when the video supplied by the user is sufficiently similar to the video passcode associated with the object.

More specifically, in some implementations, the video passcode associated with the object includes a movement. In this case, when the user makes a new video recording to be used for accessing the object, the new video recording should include the same or a similar movement. For example, if the video passcode associated with the object includes the user's face smiling or winking, the new video recording should also include the user's face smiling or winking When comparing the video supplied by the user to the video passcode associated with the object, the movement captured in the video supplied by the user is compared to the movement captured in the video passcode associated with the object. If the two movements are sufficiently similar (e.g., the same kind of movements), then the user is authenticated and access to the object is granted. Otherwise, access to the object is denied to the user.

As indicated above, a video passcode may be used for controlling access to any applicable object. As an example, with mobile telephones, a mobile telephone may be locked after it has not been actively used for some period of time. Thereafter, its user needs to provide the correct passcode in order to unlock the telephone again. In this case, a video passcode may be used to unlock a mobile telephone, as many mobile telephones now incorporate cameras (e.g., especially forward-facing cameras) capable of capturing and recording videos. The user may record, for example, a short video capturing the user's face smiling and associate this video with the mobile telephone as a passcode for unlocking the telephone. The video passcode maybe stored on the telephone itself. Thereafter, when the user needs to unlock the mobile telephone, he may record another video (e.g., again, of the user's face smiling) using the camera incorporated in the mobile telephone. This video is then compared against the video passcode previously recorded and associated with the mobile telephone. If the face smiling captured in the video supplied by the user is the same as or similar to the face smiling captured in the video passcode previously associated with the mobile telephone (e.g., based on facial recognition and other applicable image processing techniques), then the telephone is unlocked. Otherwise, the telephone remains locked.

In particular embodiments, different video passcodes may be respectively associated with different objects. As an example, a user may use one video passcode to unlock his mobile telephone and another video passcode to access his emails. The user may record, for example, a second short video capturing the user's face frowning and associate this second video with his email account. After the user records and supplies a video of his face smiling to unlock his mobile telephone, in order to access his emails on the telephone, the user needs to record another video of his face frowning, again using the camera incorporated in the mobile telephone. This video of the user's face frowning is compared against the video passcode associated with the user's email account.

Sometimes, an object may be accessed by multiple users. For example, a database may be accessed by a group of users. In particular embodiments, an object may be associated with multiple video passcodes belonging to multiple users, respectively. Each authorized user may record his own personal video passcode and associate his personal video passcode with the object. Thereafter, when a user desires to access the object, the user records and supplies another video. This video is then compared with the personal video passcode of that user in order to determine whether access to the object should be granted to the user.

The method illustrated in FIG. 1 may be performed by one or more computing devices (e.g., computers, mobile telephones, consoles, etc.). For example, the method may be implemented as computer software stored in one or more computer-readable non- transitory storage medium and executed by a processor. FIG. 2 illustrates an example computer system.

In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 200 may include one or more computer systems 200; be unitary or distributed; span multiple locations; span multiple machines; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include an HDD, a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

This disclosure contemplates one or more computer-readable storage media implementing any suitable storage. In particular embodiments, a computer-readable storage medium implements one or more portions of processor 202 (such as, for example, one or more internal registers or caches), one or more portions of memory 204, one or more portions of storage 206, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

Herein, reference to a computer-readable non-transitory storage medium may include a semiconductor-based or other integrated circuit (IC) (such as, for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, another suitable computer-readable non-transitory storage medium, or a suitable combination of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by one or more computing devices, comparing a first video provided by a user with a second video associated with an object;
authenticating the user based on whether the first video matches the second video; and
granting the user access to the object when the first video sufficiently matches the second video.

2. The method of claim 1, wherein:
the first video comprises a first movement;
the second video comprises a second movement; and
the first video sufficiently matches the second video and the user is authenticated when the first movement and the second movement are similar or the same.

3. The method of claim 2, wherein the first movement and the second movement are each a movement involving the user's face.

4. The method of claim 1, wherein the object is a physical or virtual object.

5. The method of claim 4, further comprising denying the user access to the object when the first video does not match the second video.

6. The method of claim 5, wherein:
the object is a mobile telephone comprising a camera; and
the mobile telephone is unlocked when the first video sufficiently matches the second video.

7. The method of claim 6, further comprising recording the first video with the camera of the mobile telephone.

8. The method of claim 4, further comprising:
recording the second video; and
associating the second video with the object as a passcode for the object.

9. An apparatus comprising:
a memory comprising instructions executable by one or more processors; and
the one or more processors coupled to the memory and operable to execute the instructions, the one or more processors being operable when executing the instructions to:
compare a first video provided by a user with a second video associated with an object;
authenticate the user based on whether the first video matches the second video; and
grant the user access to the object when the first video sufficiently matches the second video.

10. The apparatus of claim 9, wherein:
the first video comprises a first movement;
the second video comprises a second movement; and
the first video sufficiently matches the second video and the user is authenticated when the first movement and the second movement are similar or the same.

11. The apparatus of claim 10, wherein the first movement and the second movement are each a movement involving the user's face.

12. The apparatus of claim 9, wherein the object is a physical or virtual object.

13. The apparatus of claim 12, wherein the one or more processors are further operable when executing the instructions to deny the user access to the object when the first video does not match the second video.

14. The apparatus of claim 13, wherein:
the object is a mobile telephone comprising a camera; and
the mobile telephone is unlocked when the first video sufficiently matches the second video.

15. The apparatus of claim 14, wherein the one or more processors are further operable when executing the instructions to record the first video with the camera of the mobile telephone.

16. The apparatus of claim 12, wherein the one or more processors are further operable when executing the instructions to:
record the second video; and
associate the second video with the object as a passcode for the object.

17. One or more computer-readable non-transitory storage media embodying logic that is operable when executed to:
compare a first video provided by a user with a second video associated with an object;
authenticate the user based on whether the first video matches the second video; and
grant the user access to the object when the first video sufficiently matches the second video.

18. The media of claim 17, wherein:
the first video comprises a first movement;
the second video comprises a second movement; and
the first video sufficiently matches the second video and the user is authenticated when the first movement and the second movement are similar or the same.

19. The media of claim 18, wherein the first movement and the second movement are each a movement involving the user's face.

20. The media of claim 17, wherein:
the object is a physical or virtual object; and
the software is further operable when executed by the one or more computer systems to deny the user access to the object when the first video does not match the second video.
